(19) United States
(12) Patent Application Publication
(10) Pub. No.: US 2011/0246217 A1
(43) Pub. Date: Oct. 6, 2011

(54) Sampling Patient Data

(75) Inventors: Sailesh Chutani, Redmond, WA (US); David M. Zar, Maryland Heights, MO (US); Nikhil J. George, Redmond, WA (US)

(73) Assignee: MobiSante Inc., Redmond, WA (US)

(21) Appl. No.: 12/938,336

(22) Filed: Nov. 2, 2010

Related U.S. Application Data
(60) Provisional application No. 61/400,709, filed on Aug. 2, 2010.
(60) Provisional application No. 61/341,734, filed on Apr. 5, 2010.

(51) Int. Cl. G06Q 50/00

(52) U.S. Cl. 705/2

(57) ABSTRACT

In an embodiment, a computer includes one or more processors; a computer readable storage medium comprising a sequence of instructions, which when executed by the one or more processors, cause: transmitting, to a second computer over a network, a first subset of patient data; receiving, from the second computer, a command for additional data, wherein the command is based on the first subset of the patient data; identifying a second subset of the patient data based on the command; transmitting, to the second computer, the second subset of the patient data; wherein the first subset of the patient data and the second subset of the patient data were collected by one or more biometric sensors within a same medical examination session.

### CROSS-REFERENCE TO RELATED APPLICATIONS; BENEFIT CLAIM

This application claims the benefit under 35 U.S.C. §119(e) of Provisional Appln. 61/400,709, filed Aug. 2, 2010, the entire content of which is hereby incorporated by reference as if fully set forth herein.

This application claims the benefit under 35 U.S.C. §119(e) of Provisional Appln. 61/341,734, filed Apr. 5, 2010, the entire content of which is hereby incorporated by reference as if fully set forth herein.

### TECHNICAL FIELD

The present disclosure generally relates to sampling patient data. The disclosure relates more specifically to sampling patient data based on a command received from a remote system.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

The advent of medical diagnostic devices has changed the manner in which medical personnel collect and evaluate patient data. Medical diagnostic devices include biometric sensors such as ultrasound probes which can collect patient data for visualizing subcutaneous body structures including tendons, muscles, joints, vessels and internal organs for possible pathology or lesions. For example, obstetric sonography, which is commonly used during pregnancy may be used to visualize a fetus.

Traditionally medical diagnostic devices have been large in size and stationed in particular rooms within a hospital setting or medical office. Recently, portable medical diagnosis devices have been developed for collecting data from patients in their homes, medical offices, or other suitable locations. The portable medical diagnosis devices are generally lower in costs and are more accessible for patients.

### BRIEF DESCRIPTION OF THE DRAWINGS

In the drawings:

FIG. 1A illustrates a computer system in accordance with an embodiment;

FIG. 1B illustrates an example of data sampling logic;

FIG. 2 illustrates sampling patient data;

FIG. 3 illustrates an example of a biometric sensor;

FIG. 4 and FIG. 5 illustrate examples of one or more computers upon which one or more embodiments may be implemented.

### DETAILED DESCRIPTION OF ONE OR MORE EXAMPLE EMBODIMENTS

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### General Overview

In an embodiment, a computer includes one or more processors; a computer readable storage medium comprising a sequence of instructions, which when executed by the one or more processors, cause: transmitting, to a second computer over a network, a first subset of patient data; receiving, from the second computer, a command for additional data, wherein the command is based on the first subset of the patient data; identifying a second subset of the patient data based on the command; transmitting, to the second computer, the second subset of the patient data; wherein the first subset of the patient data and the second subset of the patient data were collected by one or more biometric sensors within a same medical examination session.

Transmitting the first subset of the patient data may include streaming a first sampling of a particular portion of the patient data, as the patient data is collected by the one or more biometric sensors; wherein the command selects the particular portion of the patient data; wherein transmitting the second subset of the patient data comprises transmitting a second sampling of the particular portion of the patient data.

In an embodiment, the computer readable storage medium includes further instructions, which when executed by the one or more processors cause: while the patient data is being collected, continuously updating a buffer at least by: storing newly-collected patient data in the buffer and deleting at least a portion of previously-collected patient data from the buffer. Responsive to receiving the command, at least a portion of the patient data that was stored in the buffer when the command was received is transmitted to the second computer.

In an embodiment, the computer readable storage medium includes further instructions, which when executed by the one or more processors cause: pausing the updating of the buffer in response to receiving the command.

The first subset of the patient data may be collected by the one or more biometric sensors based on a first protocol, and the second subset of the patient data may be collected by the one or more biometric sensors using a second protocol identified by the command. The command may include at least one configuration parameter for the one or more biometric sensors, the at least one configuration parameter selected from a group comprising of: display resolution, sampling rate, gain value, intensity value, contrast value, or depth value.

In an embodiment, the first subset of the patient data comprises a first sampling of the patient data based a first sampling rate; wherein the second subset of the patient data comprises a second sampling of the patient data based a second sampling rate.

The one or more biometric sensors may include an ultrasound probe.

In an embodiment, the command selects a portion of the first subset of patient data, and wherein the second subset of patient data comprises additional information related to the selected portion.

In an embodiment, the computer readable storage medium includes further instructions, which when executed by the one or more processors cause: configuring a camera to capture at least one image of a patient, wherein the at least one image is associated with the first subset of patient data; concurrently with transmitting the first subset of patient data, transmitting the at least one image to the second computer.

In other aspects, the disclosure encompasses an apparatus with means for the functionality described herein and a computer readable medium comprising instructions, which when executed by one or more processors provide the functionality described herein.

In other aspects, the disclosure encompasses a method performed by a computer and including one or more of the steps described herein.

### Structural Overview

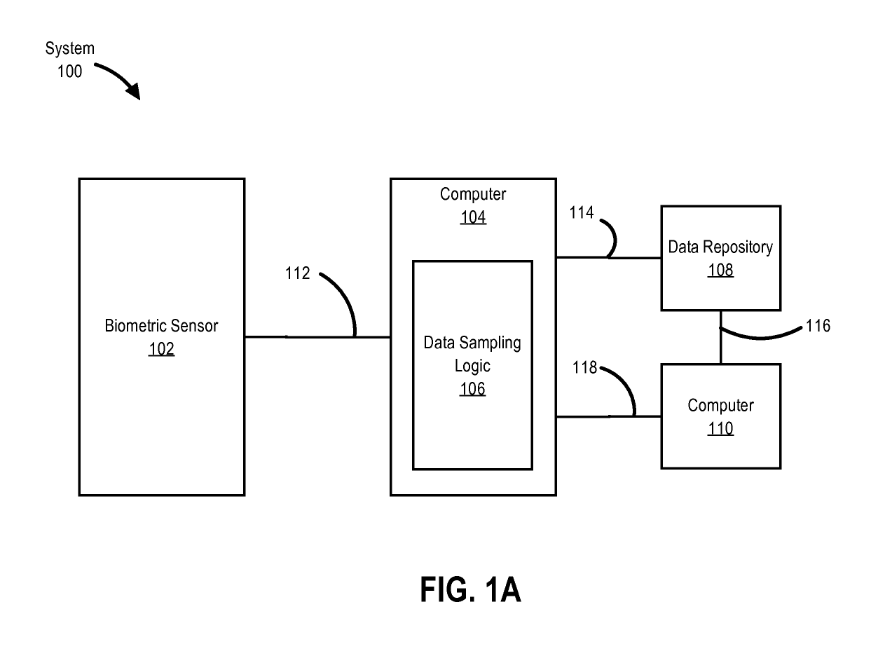

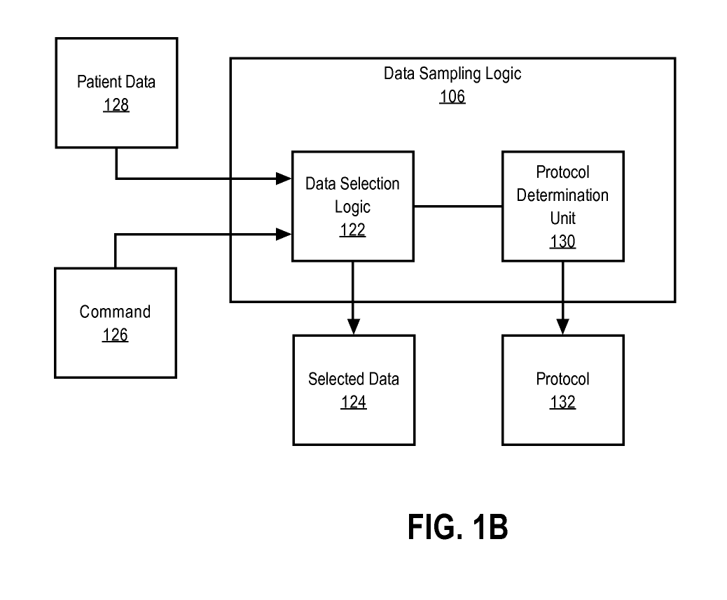

FIG. 1A illustrates a system in accordance with an embodiment. Although a specific system is described, other embodiments are applicable to any system that can be used to perform the functionality described herein. FIG. 1A illustrates a hypothetical system 100. Components of the system 100 may be connected by, without limitation, a network such as a Local Area Network (LAN), Wide Area Network (WAN), the Internet, Intranet, Extranet with terrestrial, satellite or wireless links, etc. Thus, in an embodiment, links 112, 114, 116, and 118 may each comprise a network link or cable. Alternatively or additionally, any number of devices connected within the network may also be directly connected to each other through wired or wireless communication segments. One or more components described within system 100 may be combined together in a single device. For example, sensor 102 may be integrated with computer 104; and computer 110 and data repository 108 may be remotely coupled with computer 104 through one or more networks.

In an embodiment, the system 100 includes one or more biometric sensors (e.g., biometric sensor 102), two or more computers (e.g., computer 104 and computer 110), and one or more data repositories (e.g., data repository 108).

In an embodiment, the biometric sensor 102 generally represents any sensor used to collect data related to a patient, which may be referred to herein as patient data. Patient data may include, without limitation, raw data collected from a patient, an analysis of the patient data, textual information based on raw data, or images based on the raw data. The biometric sensor 102 may collect patient data, for example, within a particular range from the patient, in direct contact with the patient, or applied to the patient through a conductive medium (e.g., gel).

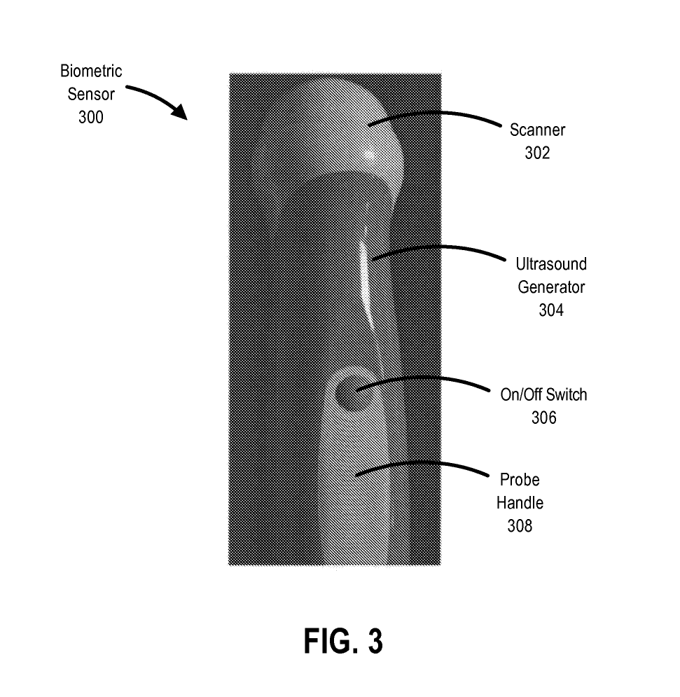

A biometric sensor 102 may refer to, for example, an ultrasound probe which collects patient data through sound waves (e.g., with a frequency of 3.5 MHz, 5 MHz, 7.5 MHz, 12 MHz, etc.). FIG. 3 illustrates an ultrasound probe 300 as an example of a biometric sensor 102. An ultrasound probe may include a scanner 302, an ultrasound generator 304 to generate sound waves that are applied toward a patient through a gel or other conductive medium, an on/off switch 306, and a probe handle 308. An ultrasound probe may further include a receiver for capturing sound wave echoes which are used to generate image data to visualize subcutaneous body structures (e.g., tendons, muscles, joints, vessels, internal organs, fetuses in pregnant women). A biometric sensor 102 may be a handheld device which is operated by an operator (e.g., human or robotic operator). Other examples of biometric sensors include, without limitation, medical cameras, electrocardiogram sensors, pulse oxymeters, and blood glucose monitors.

In an embodiment, the biometric sensor 102 may be used to collect patient data based on a protocol. A protocol generally represents directions for any procedure performed by an operator of the biometric sensor 102. A protocol may be represented in data stored in computer storage. A protocol may define organs that are to be probed and/or measured, actions that are to be performed by an operator, biometric sensor settings (e.g., gain control, intensity, contrast, depth, etc.), locations on a patient where the biometric sensor 102 is to be placed, etc.

In an embodiment, each protocol may correspond to one or more exams. For example, a protocol may define a particular procedure to test for symptoms or indications related to a particular disease or other medical diagnosis.

Furthermore, protocols may differ based on the patient. For example, thin patients may require a different protocol than obese patients in order to obtain useful patient data.

In an embodiment, computer 104 generally represents any device that includes a processor and is communicatively coupled with the biometric sensor 102. Examples of computer 104 include, without limitation, a desktop, a laptop, a tablet, a cellular phone, a smart phone, a personal digital assistant, a kiosk, etc. Computer 104 may be communicatively coupled with the biometric sensor 102 with wired and/or wireless segments. Computer 104 may be connected directly with the biometric sensor 102 using a universal serial bus (USB) cable.

Computer 104 may be used for determining or receiving one or more protocols for use with the biometric sensor 102 to collect patient data as described below with respect to FIG. 1B. In an embodiment, computer 104 includes a data sampling logic 106, which may comprise firmware, hardware, software, or a combination thereof in various embodiments that can implement the functions described herein.

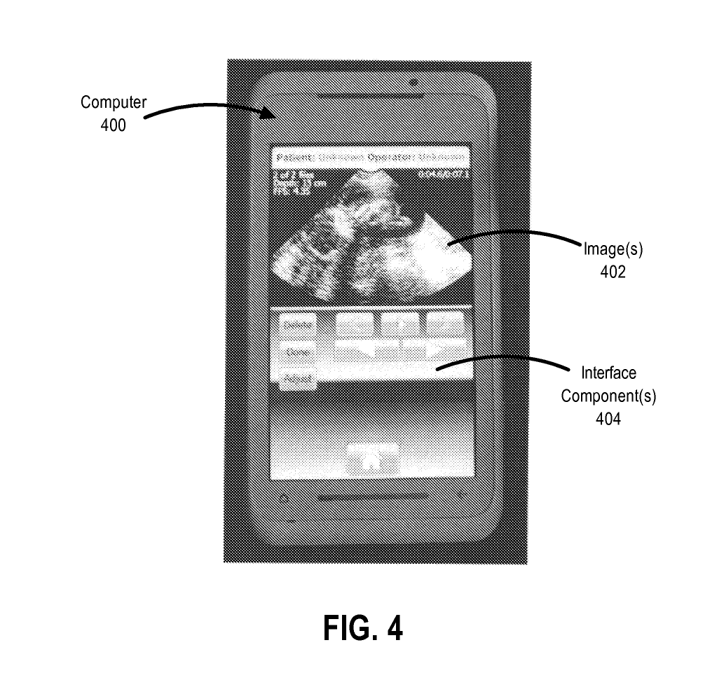

FIG. 4 illustrates a computer 400, as an example of computer 104, that may be used with a biometric sensor 102 such as an ultrasound probe. In an embodiment, computer 400 may include one or more buffers for temporarily or permanently recording patient data. For example, computer 400 may include logic configured to display images 402 (or any other patient information) based on the patient data collected by the biometric sensor 102. Data recorded in any buffer within computer 400 may be sampled at varying rates and using varying techniques. For example, every other image within a buffer may be sampled and transmitted to another computer (e.g., computer 110). In another example, every other horizontal vector or vertical vector from each image may be sampled and transmitted. A portion of interest of each image may be selected and transmitted. Different buffers within computer 400 may record the same patient data with varying levels of quality. For example, a particular buffer may include all patient data and another buffer may include a portion (e.g., based on sampling rate) of the patient data.

In an embodiment, a buffer may be configured to store patient data corresponding to a window of time. For example, a buffer may be continuously update to store newly-collected patient data while deleting at least a portion of previously-collected patient data from the buffer. A buffer may include patient data collected, for example, within the last ten minutes a current time. Patient data stored within a buffer at a particular time may be stored in a different location to avoid deletion or may be transmitted to a remote system.

In an embodiment, the computer 400 may be configured to tag patient data with one or more attributes. Examples of attributes include, without limitation, patient information, geographical information, and environmental information. Patient information may refer to nationality, ethnicity, place of residence, place of work, socio-economic group, age, genetic characteristics, behavioral habits, lifestyle habits, etc. of a patient from whom the patient data is collected. Patient information may further include a patient condition when the patient data was collected. For example, the patient information may indicate that the patient data was collected after a twelve hour fast, after a five minute jog, etc. Geographical information may refer to a location where the patient data was collected, information about a location where the patient data was collected, etc. Environmental information may refer to specific chemicals (e.g., pollutants found in land, water, or air within a geographical area) within an environment, general environmental quality ratings or conditions, etc. In an embodiment, the computer 400 may be configured to categorize patient data based on one or more attributes. For example, the computer 400 may be configured to manage, access, edit, or search patient data using a query for patients over the age of sixty-five that smoke tobacco. In an embodiment, patient data collected by one or more biometric sensors 102 may be stored on a local computer 104 or a remote computer 110 as aggregate medical information 126, described below in relation to FIG. 1B.

In an embodiment, computer 400 may include one or more interface components 404 to add, edit, delete, display, or send data accessible to the computer 400. The interface components 404 may be used to manage the biometric sensor 102.

In an embodiment, the data repository 108 generally represents any data storage device known in the art which may be configured to store data. Examples include local memory on computer 104, local memory on computer 110, shared memory, multiple servers connected over the internet, systems within a local area network, a memory on a mobile device, etc. In one or more embodiments, access to the data repository 108 may be restricted and/or secured. Access to the data repository 108 may require authentication using passwords, secret questions, personal identification numbers (PINs), and/or any other suitable authentication mechanism. Portions of data stored in the data repository 108 may be distributed and stored in multiple data repositories (e.g., servers across the world).

In one or more embodiments, the data repository 108 includes flat, hierarchical, network based, relational, dimensional, object modeled, or data files structured otherwise. For example, data repository 108 may be maintained as a table of an SQL database. In addition, data in the data repository 108 may be verified against data stored in other repositories.

Computer 110 may be implemented as described herein in relation to computer 104. Computer 110 may be located remotely from biometric sensor 102 and computer 104. Computer 110 may obtain data collected by the biometric sensor 108 directly from the biometric sensor 108 or via computer 104. Computer 110 may be operated by a remote user to provide instructions which are transmitted to computer 104. Computer 104 or computer 110 may be configured to determine or receive one or more protocols for operating the biometric sensor 108. Computer 104 or computer 110 may comprise an analysis workstation for evaluating patient data.

### Architectural and Functional Overview

FIG. 1B illustrates an example of a data sampling logic 106. In an embodiment, the data sampling logic 106 comprises a data selection logic 122 and a protocol determination unit 130. One or more components of the data sampling logic 106 may be located on a different computer (e.g., computer 110) that is communicatively coupled with computer 104.

In an embodiment, the data selection logic 122 includes logic configured to select data 124 from patient data 128 that is collected by one or more biometric sensors. The data selection logic 122 may select a portion of available patient data 128 or all of available patient data 128. The data selection logic may obtain a sample of the patient data 128 according to a particular sampling rate. For example, if the patient data 128 includes a set of images collected over time, then the data selection logic 122 may select a subset of the images that were collected every n^{th} second.

The data selection logic 122 may be configured to sample a portion of data collected at a particular time. For example, if a portion of data collected at time x is presented as an image, the data selection logic 122 may select a portion of that image. The selected portion may include particular horizontal sections or particular vertical sections of the image. For example, the selected portion may include alternating horizontal sections from the horizontal sections that are comprised in an image. The selected portion may include an area of interest within the data (e.g., top right region of an image, region of image that is associated with particular body organ, etc.). The data selection logic 122 may be configured to sample a portion of data by compressing the data and using the resulting compressed file as a sample of the data.

The data selection logic 122 may include logic configured to compare patient data to one or more symptoms related to a medical diagnosis and select a portion of the patient data that matches the one or more symptoms. The data selection logic 122 may select different portions of data collected over time. For example, the data selection logic 122 may select portions of data which identify the progress of a spreading disease. In an embodiment, the data selection logic 122 includes logic configures to compress patient data. The data selection logic 122 may compress patient data using lossy compression techniques or lossless compression techniques. The compressed patient data may be referred to herein as the selected data 124.

In an embodiment, the data selection logic 122 may select data 124 from patient data 128 based on a command 126. A command 126 may refer to any instructions received from a remote computer and/or a separate computer (e.g., computer 110). In an embodiment, the command may specifically identify a portion of the patient data 128 that is to be selected. For example, the command 126 may identify a body organ for selection of data related to that body organ. The command 126 may indicate an image resolution or other data quality characteristic. In an embodiment, the command may identify a protocol for obtaining the selected data 124. For example, the command may indicate device settings or an action to be performed by a user with an ultrasound probe which would result in obtaining the selected data 124.

In an embodiment, the protocol determination unit 130 includes logic configured for determining or selecting one or more protocols (e.g., protocol 132) for collecting patient data with the biometric sensor 102. As described above, a protocol generally represents any directions for a procedure performed by a human or machine operator of the biometric sensor 102 for collecting patient data via the biometric sensor 102. In an embodiment, the protocol determination unit 130 may determine the protocol 132 based on the command 126. For example, if the command 126 identifies patient data that is not yet collected, the protocol determination unit 130 may determine a procedure for collecting the identified patient data. In an embodiment, the protocol determination unit 130 may select a protocol from a database that is identified by the command 126.

All components of the data sampling logic 106 may be integrated into a single unit of software, firmware, or a combination. Thus, the separate blocks shown in FIG. 1B are provided solely to illustrate one example.

### Data Sampling Procedure

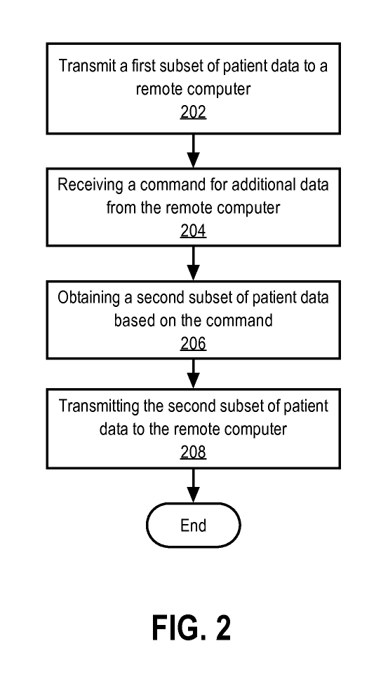

FIG. 2 illustrates an example of data sampling. FIG. 2 may represent an algorithm that may be embodied in or hosted by the data sampling logic 106. In an embodiment, one or more of the steps described below may be omitted, repeated, or performed in a different order. The specific arrangement shown in FIG. 2 is not required.

In Step 202, a first subset of patient data is transmitted from a local computer to a remote computer. For example, computer 104 may obtain patient data in response to an operator operating biometric sensor 104, and send the patient data to computer 110 over a network. In an embodiment, patient data may be stored in a buffer as the patient data is being collected. The patient data being collected may be sampled to obtain the first subset of patient data for transmission. Transmitting the first subset of patient data may comprise streaming the first subset of the patient data as the patient data is being collected. For example, as the patient data is being collected and stored in a buffer at computer 104, a compressed version of the same data may be transmitted to computer 110. In addition, images or video may be collected as a part of the patient data and transmitted with the patient data to computer 110.

In an embodiment, transmitting the first subset of patient data includes transmitting information associated with the first subset of the patient data. For example, information related to how the first subset of patient data was obtained, difficulties involved in obtaining the first subset of patient data, and trends associated with the first subset of patient data may be obtained at computer 104 and sent to computer 110. The information may include patient information that is relevant to the first subset of patient data. For example, the information may include the patient's weight, blood pressure, cholesterol levels, etc. Transmitting the first subset of patient data may include transmitting a list of options related to the first subset of patient data. For example, if the patient data is indicative of two possible diseases, the first subset of patient data may be transmitted with options for requesting additional patient data related to the two possible diseases. The option data may comprise values that an operator previously entered in computer 104 to configure computer 104 for a particular patient, protocol, or exam.

In an embodiment, the first subset of patient data may be related to internal organs. For example, the first subset of patient data may be obtained by an ultrasound probe and may indicate a visualization of one or more internal organs. The first subset of patient data may be transmitted with a picture of a patient that was taken during the same patient visit as when the first subset of patient data was collected. The picture may be of an area on the patient's body around which one or more biometric sensors were placed for collecting the patient data. In an embodiment, a video of a medical examination in which the patient data is being collected may be transmitted concurrently with the patient data.

In Step 204, a command for additional data is received at a local computer such as computer 104, from a remote computer such as computer 110, based on the first subset of patient data. In an embodiment, the command may be received at computer 110 through data input (e.g., textual input through a keyboard or mouse), voice input, video input, or any other type of input capable of indicating a command. The command submitted at computer 110 may be received at computer 110 in the same form as the command was entered. For example, a video of an operator at computer 110 may be transmitted and displayed at computer 104. In an embodiment, a command form may be modified. For example, a command submitted as voice input by an operator at computer 110 may be converted to text and displayed on a screen at computer 104.

The command may request a second version of the first subset of patient data with greater detail. For example, the command may request a set of high resolution images corresponding to low resolution images represented in the first subset of patient data. The command may request a sample of patient data based on a higher sampling rate than the sample included in the first subset of patient data.

In an embodiment, the command may include a modification of the protocol used to obtain the first subset of patient data. For example, the command may include instructions on obtaining data, for a particular organ, that was not included in the first subset of patient data.

The command may provide operator or computer instructions for handling a biometric sensor (e.g., direction of movement, speed, acceleration, etc.). The command may be related to a device setting or configuration for one or more biometric sensors being used for collecting patient data. For example, the command may list biometric sensor attachments, display resolution, sampling rate, gain value, intensity value, contrast value, or depth value.

In an embodiment, the received command may be based on a manual or computer-based evaluation of the first subset of the patient data. For example, an evaluation of the first subset of patient data may be used to identify one or more symptoms of a particular medical diagnosis (e.g., a disease, a condition, etc.). Based on the identification of one or more symptoms, the received command may include instructions to test a patient for that particular medical diagnosis. In an embodiment, the first subset of patient data may be evaluated for accuracy, completeness, and/or quality. Based on the evaluation of the first subset of patient data, the received command may include instructions for collecting the patient data again. For example, a command to collect the patient data again may be received based on a determination that the patient data does not include all needed information. This determination is based on a sample of the patient data, e.g., the first subset of the patient data. In an embodiment, a command may select data stored in a buffer when the command is received.

In Step 206, a second subset of patient data is obtained, for transmission to a remote computer, based on the command. For example, computer 104 may select the second subset of patient data and transmit the second subset of patient data to computer 110. In an embodiment, identification of the second subset of patient data may involve identifying already obtained data that is selected by the command. For example, based on a command which selects a particular organ, all patient data related to that particular organ may be identified. In another example, based on a command which selects current data, all patient data stored in a buffer at the time the command is received is identified for transmission.

In an embodiment, identifying the second subset of the patient data may involve sampling the already obtained patient data at a different sampling rate than the first subset of the patient data. For example, the first subset of patient data, which may be a sample of the patient data at a low sampling rate, may be evaluated to deduce that the patient data as a whole is suitable for a medical diagnosis. Based on this deduction, the command may request all of the patient data which was sampled to obtain the first subset of the patient data. In another example, based on the deduction, the command may request a second subset of the patient data at a higher sampling rate than a sampling rate used for obtaining the first subset of the patient data.

In an embodiment, identifying the second subset of the patient data may involve collecting the second subset of the patient data based on instructions received in the command. For example, the second subset of the patient data may be collected by the biometric sensor 102 from the patient based on instructions received from computer 110 during the same medical examination session as the first subset of patient data. A same medical examination session may refer to the same visit between the patient and the human or machine operator of the one or more biometric sensors. For example, if the command indicates that the patient data must be collected again, identifying the second subset of the patient data may involve collecting additional patient data. If a command indicates a protocol for collecting patient data, the second subset of the patient data may be collected based on that protocol. If a command requests data, a protocol may be determined based on the command to collect the requested data. In an embodiment, identifying the second subset of patient data may involve sampling the collected patient data.

In Step 208, the second subset of patient data is transmitted to the remote computer. For example, upon obtaining, selecting, or identifying the second subset of patient data, computer 104 may transmit the second subset of patient data to computer 110. Transmitting the second subset of patient data to the remote computer may involve similar steps as transmitting the first subset of the remote computer, as described above. In an embodiment, any number of subsets of patient data may be requested by computer 110 and transmitted to computer 110 by computer 104.

### Data Sampling Example

In one particular example, which should not be construed to limit the scope described herein, an ultrasound probe is used by an operator as biometric sensor 300 to collect patient data from a patient. Newly-collected patient data is stored in a buffer at a local computer 104 as previously-collected patient data is deleted from the computer 104. The buffer maintains patient data collected within a window of time from a current time to a previous time. In addition, low resolution ultrasound images are generated from the patient data and streamed in real-time to a remote computer 110. The remote computer 110 displays the low resolution ultrasound images as they are received.

A remote viewer at the remote computer system then evaluates the low resolution ultrasound images to determine whether the low resolution ultrasound images are appropriate, whether the low resolution ultrasound images focus on the right body part, and/or whether a position of the ultrasound probe needs to be changed. Being satisfied with the low resolution ultrasound images, the remote viewer then submits data or voice input at the remote computer 110 indicating approval. The local computer 104 receives a command from the remote computer 110 based on the remote viewer's input indicating approval. As soon as the local computer receives the command, the local computer 104 stops updating the buffer or deleting any content from the buffer. The local computer 104 then sends high resolution ultrasound images generated from the patient data stored in the buffer. The buffer at the local computer 104 may store high resolution ultrasound images based on raw patient data, instead of or in addition to the raw patient data itself. The high resolution ultrasound images may be sampled to generate the low resolution ultrasound images that were initially sent to the remote computer 110.

### Hardware Overview

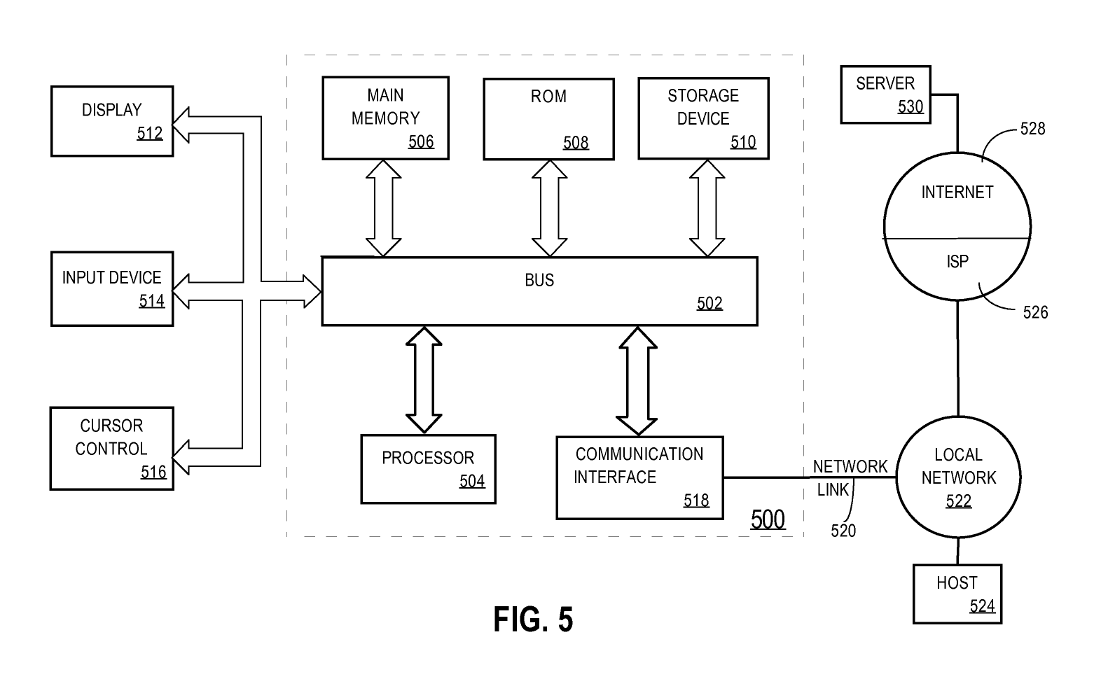

FIG. 5 is a block diagram that illustrates a computer system 500 upon which an embodiment may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer comprising:
one or more processors;
a computer readable storage medium comprising a sequence of instructions, which when executed by the one or more processors, cause:
transmitting, to a second computer over a network, a first subset of patient data;
receiving, from the second computer, a command for additional data, wherein the command is based on the first subset of the patient data;
identifying a second subset of the patient data based on the command;
transmitting, to the second computer, the second subset of the patient data;
wherein the first subset of the patient data and the second subset of the patient data were collected by one or more biometric sensors within a same medical examination session.

2. The computer as recited in claim 1,
wherein the instructions that cause transmitting the first subset of the patient data comprises instructions that cause streaming a first sampling of a particular portion of the patient data, as the patient data is collected by the one or more biometric sensors;
wherein the command selects the particular portion of the patient data;
wherein the instructions that cause transmitting the second subset of the patient data comprises instructions that cause transmitting a second sampling of the particular portion of the patient data.

3. The computer as recited in claim 1, further comprising instructions which when executed cause:
while the patient data is being collected, continuously updating a buffer at least by:
storing newly-collected patient data in the buffer;
deleting at least a portion of previously-collected patient data from the buffer;
responsive to receiving the command, transmitting, to the second computer, at least a portion of the patient data that was stored in the buffer when the command was received.

4. The computer as recited in claim 3, further comprising instructions which when executed cause pausing the updating of the buffer in response to receiving the command.

5. The computer as recited in claim 1, wherein the first subset of the patient data is collected by the one or more biometric sensors based on a first protocol, and wherein the second subset of the patient data is collected by the one or more biometric sensors using a second protocol identified by the command.

6. The computer as recited in claim 1, wherein the command comprises at least one configuration parameter for the one or more biometric sensors, the at least one configuration parameter comprising any of: display resolution, sampling rate, gain value, intensity value, contrast value, or depth value.

7. The computer as recited in claim 1,
wherein the first subset of the patient data comprises a first sampling of the patient data based on a first sampling rate;
wherein the second subset of the patient data comprises a second sampling of the patient data based on a second sampling rate.

8. The computer as recited in claim 1, wherein the one or more biometric sensors comprise an ultrasound probe.

9. The computer as recited in claim 1, wherein the command specifies a portion of the first subset of patient data, and wherein the second subset of patient data comprises additional information related to the selected portion.

10. The computer as recited in claim 1, further comprising instructions which when executed cause:
configuring a camera to capture at least one image of a patient, wherein the at least one image is associated with the first subset of patient data;
concurrently with transmitting the first subset of patient data, transmitting the at least one image to the second computer.

11. A method comprising:
transmitting, to a second computer over a network, a first subset of patient data;
receiving, from the second computer, a command for additional data, wherein the command is based on the first subset of the patient data;
identifying a second subset of the patient data based on the command;
transmitting, to the second computer, the second subset of the patient data;
wherein the first subset of the patient data and the second subset of the patient data were collected by one or more biometric sensors within a same medical examination session.

12. The method as recited in claim 11,
wherein transmitting the first subset of the patient data comprises transmitting a first sampling of a particular portion of the patient data, as the patient data is collected by the one or more biometric sensors;
wherein the command selects the particular portion of the patient data;
wherein transmitting the second subset of the patient data comprises transmitting a second sampling of the particular portion of the patient data.

13. The method as recited in claim 11, wherein the steps further comprising:
while the patient data is being collected, continuously updating a buffer at least by:
storing newly-collected patient data in the buffer;
deleting at least a portion of previously-collected patient data from the buffer;
responsive to receiving the command, transmitting, to the remote computer, at least a portion of the patient data that was stored in the buffer when the command was received.

14. The method as recited in claim 13, further comprising pausing the updating of the buffer in response to receiving the command.

15. The method as recited in claim 11, wherein the first subset of the patient data is collected by the one or more biometric sensors based on a first protocol, and wherein the second subset of the patient data is collected by the one or more biometric sensors using a second protocol identified by the command.

16. The method as recited in claim 11, wherein the command comprises at least one configuration parameter for the one or more biometric sensors, the at least one configuration parameter comprising any of: display resolution, sampling rate, gain value, intensity value, contrast value, or depth value.

17. The method as recited in claim 11,
wherein the first subset of the patient data comprises a first sampling of the patient data based on a first sampling rate;
wherein the second subset of the patient data comprises a second sampling of the patient data based on a second sampling rate.

18. The method as recited in claim 11, wherein the one or more biometric sensors comprise an ultrasound probe.

19. The method as recited in claim 11, wherein the command specifies a portion of the first subset of patient data, and wherein the second subset of patient data comprises additional information related to the selected portion.

20. The method as recited in claim 11, the steps further comprising:
configuring a camera to capture at least one image of a patient, wherein the at least one image is associated with the first subset of patient data;
concurrently with transmitting the first subset of patient data, transmitting the at least one image to the remote computer.

21. A non-transitory computer readable storage medium comprising instructions, which when executed by one or more processors, cause:
transmitting, to a remote computer over a network, a first subset of patient data;
receiving, from the remote computer, a command for additional data, wherein the command is based on the first subset of the patient data;
identifying a second subset of the patient data based on the command;
transmitting, to the remote computer, the second subset of the patient data;
wherein the first subset of the patient data and the second subset of the patient data were collected by one or more biometric sensors within a same medical examination session.

22. The computer readable medium as recited in claim 21,
wherein the instructions that cause transmitting the first subset of the patient data comprises instructions that cause streaming a first sampling of a particular portion of the patient data, as the patient data is collected by the one or more biometric sensors;
wherein the command selects the particular portion of the patient data;
wherein the instructions that cause transmitting the second subset of the patient data comprises instructions that cause transmitting a second sampling of the particular portion of the patient data.

23. The computer readable medium as recited in claim 21, further comprising instructions which when executed cause:
while the patient data is being collected, continuously updating a buffer at least by:
storing newly-collected patient data in the buffer;
deleting at least a portion of previously-collected patient data from the buffer;
responsive to receiving the command, transmitting, to the remote computer, at least a portion of the patient data that was stored in the buffer when the command was received.

24. The computer readable medium as recited in claim 23, further comprising instructions which when executed cause pausing the updating of the buffer in response to receiving the command.

25. The computer readable medium as recited in claim 21, wherein the first subset of the patient data is collected by the one or more biometric sensors based on a first protocol, and wherein the second subset of the patient data is collected by the one or more biometric sensors using a second protocol identified by the command.

26. The computer readable medium as recited in claim 21, wherein the command comprises at least one configuration parameter for the one or more biometric sensors, the at least one configuration parameter comprising any of: display resolution, sampling rate, gain value, intensity value, contrast value, or depth value.

27. The computer readable medium as recited in claim 21,
wherein the first subset of the patient data comprises a first sampling of the patient data based on a first sampling rate;
wherein the second subset of the patient data comprises a second sampling of the patient data based on a second sampling rate.

28. The computer readable medium as recited in claim 21, wherein the one or more biometric sensors comprise an ultrasound probe.

29. The computer readable medium as recited in claim 21, wherein the command specifies a portion of the first subset of patient data, and wherein the second subset of patient data comprises additional information related to the selected portion.

30. The computer readable medium as recited in claim 21, further comprising instructions which when executed cause:
configuring a camera to capture at least one image of a patient, wherein the at least one image is associated with the first subset of patient data;
concurrently with transmitting the first subset of patient data, transmitting the at least one image to the remote computer.
